(19) United States
(12) Patent Application Publication
(10) Pub. No.: US 2011/0140991 A1
(43) Pub. Date: Jun. 16, 2011

(54) MULTI-MONITOR CONFIGURATION SYSTEM

(75) Inventors: Robert J. Brenneman, Stormville, NY (US); Eli M. Dow, Poughkeepsie, NY (US); William J. Huie, Poughkeepsie, NY (US); Sarah J. Sheppard, Poughkeepsie, NY (US)

(73) Assignee: International Business Machines Corporation, Armonk, NY (US)

(21) Appl. No.: 12/637,837

(22) Filed: Dec. 15, 2009

(51) Int. Cl. G09G 5/00; H04B 7/00

(52) U.S. Cl. 345/1.3; 455/41.2

(57) ABSTRACT

A multi-monitor configuration system may include a plurality of monitors and a sensor carried by each of the plurality of monitors. The system may also include a controller to detect and/or configure the plurality of monitors to display at least one video signal image based upon individual monitor parameters provided by each respective sensor to the controller.

### BACKGROUND OF THE INVENTION

1. Field of the Invention

The invention relates to the field of computer systems, and, more particularly, to monitor configuration within such.

2. Description of Background

Generally, a monitor generates a non-permanent image from a video signal. The monitor is sometimes called a display, visual display unit, display screen, and/or the like.

Multiple displays are becoming more prevalent with decreasing costs in LCD screens and televisions. With each additional screen that a user wishes to add to their setup, a set of configurations must typically be made for setting screen resolution and position.

### SUMMARY OF THE INVENTION

According to one embodiment of the invention, a multi-monitor configuration system may include a plurality of monitors and a sensor carried by each of the plurality of monitors. The system may also include a controller to detect and/or configure the plurality of monitors to display at least one video signal image based upon individual monitor parameters provided by each respective sensor to the controller.

The individual monitor parameters may include the monitor's spatial position, the monitor's spatial position relative to the other monitors, and/or the monitor imaging settings. Each sensor may comprise a personal area network technology and/or a wireless personal area network technology. The wireless personal area network technology may comprise a radio-frequency identification tag, infrared data association unit, ZigBee transceiver, Bluetooth unit, optical coupler, and ultra-wideband unit.

The controller may be carried by a primary monitor, a video card, and/or a computer system. The controller may transmit a nearest neighbor signal that ripples through the plurality of monitors thereby permitting each monitor to adjust its individual monitor parameters based upon each monitor's spatial position relative to the other monitors. Each monitor may use a portion of a video image signal ascribed to it by the controller and may relay the remaining portion downstream to the other monitors.

Each sensor may comprise a plurality of sensors arranged on each monitor that aid the controller in identifying each monitor's location relative to the other monitors. The communications between the controller and each sensor may be substantially restricted to the controller and each sensor.

In another embodiment, the multi-monitor configuration system may include a plurality of monitors and a sensor carried by each of the plurality of monitors. The system may also include a controller to detect and/or configure the plurality of monitors to display at least one video signal image based upon individual monitor parameters provided by each respective sensor to the controller. The controller may transmit a nearest neighbor signal that ripples through the plurality of monitors thereby permitting each monitor to adjust its individual monitor parameters based upon each monitor's spatial position relative to the other monitors. Also, the communications between the controller and each sensor may be substantially restricted to the controller and each sensor.

In another embodiment, the multi-monitor configuration system may include a plurality of monitors and a wireless personal area network sensor carried by each of the plurality of monitors. The system may also include a controller to detect and/or configure the plurality of monitors to display at least one video signal image based upon individual monitor parameters provided by each respective sensor to the controller. Also, the communications between the controller and each sensor may be substantially restricted to the controller and each sensor.

Another aspect of the invention is a method to configure monitors. The method may include configuring each of a plurality of monitors to carry a wireless personal area network sensor. The method may also include at least one of detecting and configuring the plurality of monitors with a controller to display at least one video signal image based upon individual monitor parameters provided by each sensor to the controller, and communications between the controller and each sensor is substantially restricted to the controller and each sensor.

The method may further comprise including at least one of monitor's spatial position, monitor's spatial position relative to the other monitors, and monitor imaging settings as the individual monitor parameters. The method may additionally include transmitting, via the controller, a nearest neighbor signal that ripples through the plurality of monitors thereby permitting each monitor to adjust its individual monitor parameters based upon each monitor's spatial position relative to the other monitors.

The method may also include using a portion of a video image signal by each monitor where the portion is ascribed to each monitor by the controller and relaying the remaining portion downstream to the other monitors. The method may further include aiding the controller in identifying each monitor's location relative to the other monitors where each sensor comprises a plurality of sensors arranged on each monitor.

### BRIEF DESCRIPTION OF THE DRAWINGS

FIG. 1 is a schematic block diagram of a multi-monitor configuration system in accordance with the invention.

FIG. 2 is a schematic block diagram of an alternative embodiment of the system of FIG. 1.

FIG. 3 is a schematic block diagram of an alternative embodiment of the system of FIG. 1.

### DETAILED DESCRIPTION OF THE INVENTION

Embodiments of the invention will now be described more fully hereinafter with reference to the accompanying drawings, in which preferred embodiments of the invention are shown. Like numbers refer to like elements throughout, like numbers with letter suffixes are used to identify similar parts in a single embodiment, letter suffix lower case z is a variable that indicates an unlimited number of similar elements, and prime notations are used to indicate similar elements in alternative embodiments.

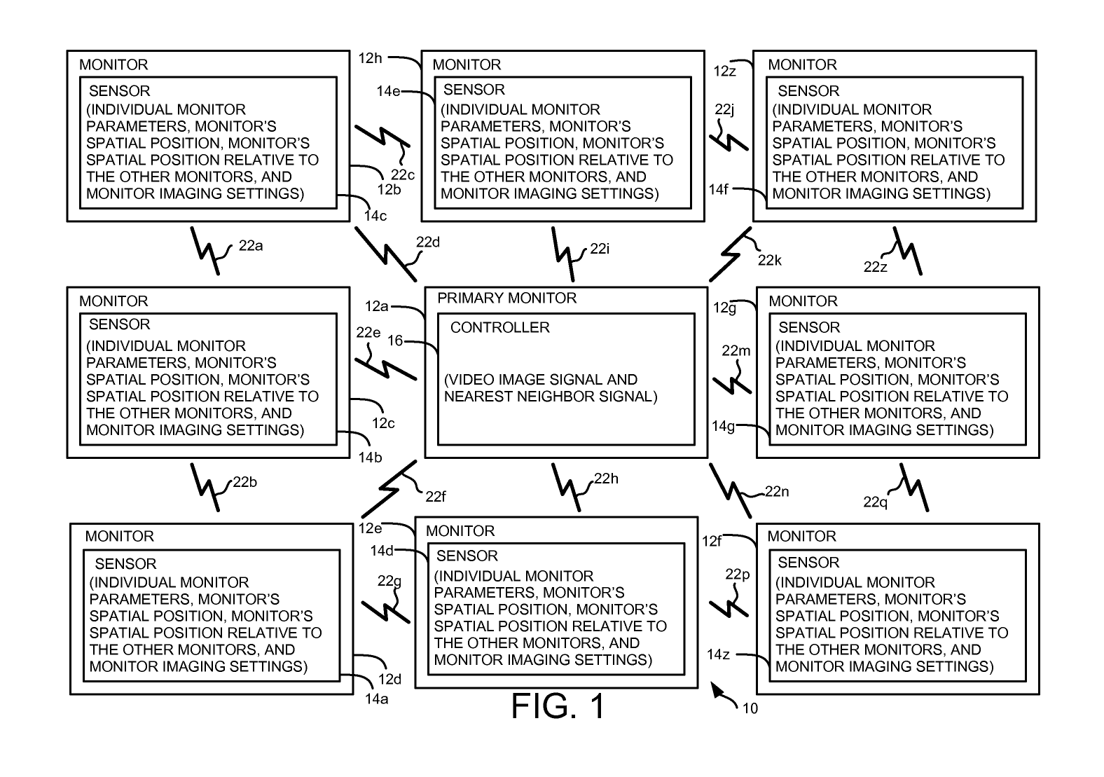

With reference now to FIG. 1, a system 10 for multi-monitor configuration is initially described. In one embodiment, the system 10 includes a plurality of monitors 12a-12z and a sensor 14a-14z carried by each of the plurality of monitors. The system 10 also includes a controller 16 to detect and/or configure the plurality of monitors 12a-12z to display at least one video signal image based upon individual monitor parameters provided by each respective sensor 14a-14z to the controller 16.

In one embodiment, the system 10 includes a communications network 22a-22z that enables a signal to travel anywhere within system 10 and/or to any other system connected to system 10. The communications network 22a-22z is wired and/or wireless, for example. The communications network 22a-22z is local and/or global with respect to system 10, for instance.

In one embodiment, the individual monitor parameters include the monitor's 12a-12z spatial position, the monitor's spatial position relative to the other monitors, and/or the monitor imaging settings. The image settings include contrast, brightness, what portion of the video signal the particular monitor 12a-12z is render into an image, and/or the like.

In one embodiment, each sensor 14a-14z comprises a personal area network technology and/or a wireless personal area network technology. In another embodiment, the wireless personal area network technology comprises a radio-frequency identification tag, infrared data association unit, ZigBee transceiver, Bluetooth unit, optical coupler, and ultra-wideband unit.

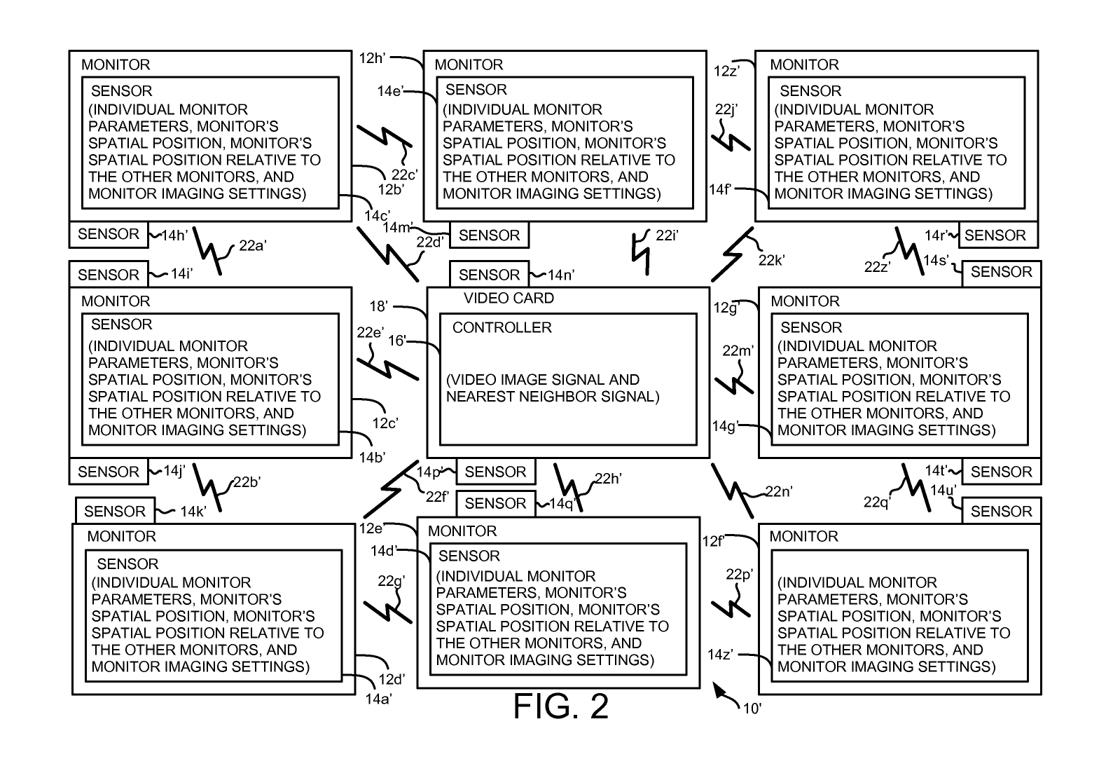

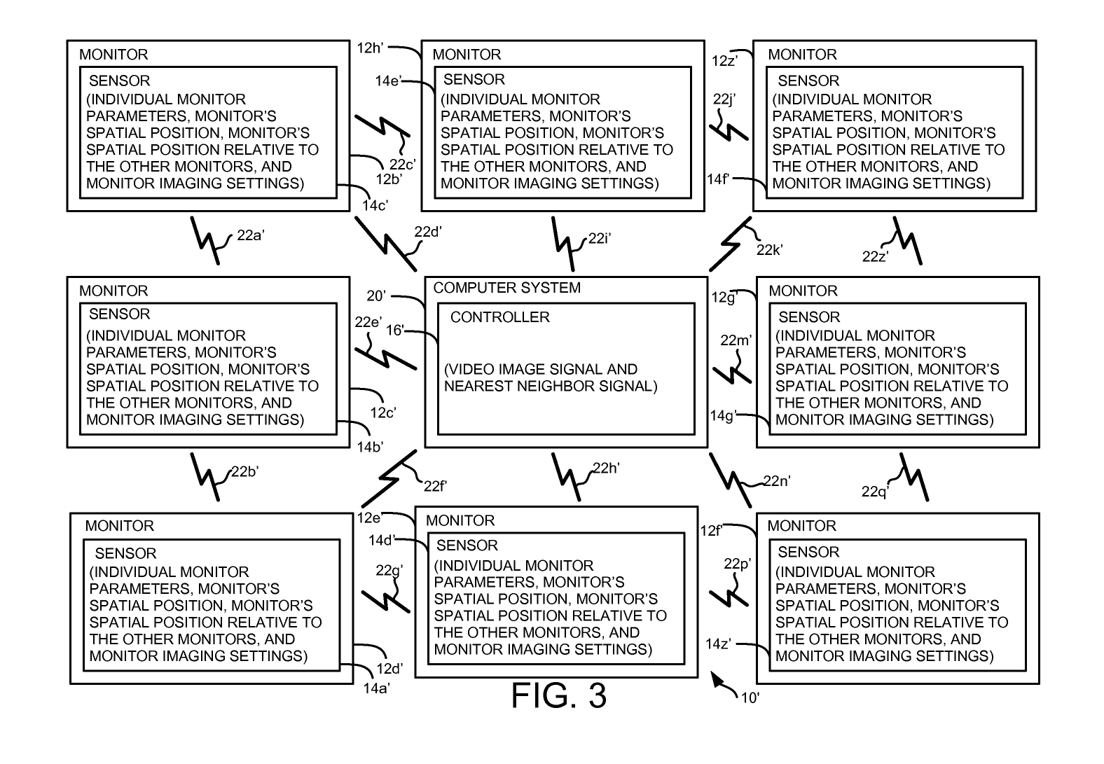

With additional reference to FIGS. 2 and 3, in one embodiment, the controller 16 is carried by a primary monitor 12a, a video card 18′, and/or a computer system 20′. The video signal comes from the computer system 20′, for example.

In one embodiment, the controller 16 transmits a nearest neighbor signal that ripples through the plurality of monitors 12a-12z thereby permitting each monitor to adjust its individual monitor parameters based upon each monitor's spatial position relative to the other monitors. In another embodiment, each monitor 12a-12z uses a portion of a video image signal ascribed to it by the controller 16 and relays the remaining portion downstream to the other monitors.

In one embodiment, each sensor 14a-14z comprises a plurality of sensors arranged on each monitor 12a-12z that aid the controller 16 in identifying each monitor's location relative to the other monitors. In another embodiment, the communications between the controller 16 and each sensor 14a-14z is substantially restricted to the controller and each sensor. In other words, the communications is shielded from other sensors and/or is private between particular sensors 14a-14z and/or between a sensor 14a-14z and the controller 16. This can be achieved by signal shielding, identification friend or foe techniques, and/or the like.

In another embodiment, the multi-monitor configuration system 10 includes a plurality of monitors 12a-12n and a sensor 14a-14n carried by each of the plurality of monitors. The system also includes a controller 16 to detect and/or configure the plurality of monitors 12a-12n to display at least one video signal image based upon individual monitor parameters provided by each respective sensor 14a-14n to the controller. The controller 16 transmits a nearest neighbor signal that ripples through the plurality of monitors 12a-12n thereby permitting each monitor to adjust its individual monitor parameters based upon each monitor's spatial position relative to the other monitors. Also, the communications between the controller 16 and each sensor 14a-14n is substantially restricted to the controller and each sensor.

In another embodiment, the multi-monitor configuration system 10 includes a plurality of monitors 12a-12n and a wireless personal area network sensor 14a-14n carried by each of the plurality of monitors. The system also include a controller 16 to detect and/or configure the plurality of monitors 12a-12n to display at least one video signal image based upon individual monitor parameters provided by each respective sensor 14a-14n to the controller. Also, the communications between the controller 16 and each sensor 14a-14n is substantially restricted to the controller and each sensor.

In view of the foregoing, the system 10 provides a multi-monitor configuration system because the system detects the position of the monitors 12a-12n and adjusting each one's settings based on its position relative to the other monitors. The system 10 reduces or eliminates the manual configuration that needs to occur when connecting multiple displays to a system. With the improvement of graphic processor units or the like, it is possible to have large numbers of monitors running from one system, e.g. video walls may have hundreds of monitors.

In one embodiment, the system 10 accomplishes this by placing a radio-frequency identification tag, infrared data association unit, ZigBee transceiver, Bluetooth unit, optical coupler, ultra-wideband unit and/or the like within, or on at least one of the four sides, of the monitor 14a-14z to be used. Each monitor 14a-14z is presumed to have a unique serial number, identifier, and/or the like. One monitor 12a is designated as the primary display (which may or may not receive a hard wire signal or perhaps wireless transmission of video via things like wifi-hd) and carries the controller 16 responsible for the awareness of all other monitors 12b-12z relative to itself. Each secondary monitor 12b-12z would need to report back to the primary monitor 12a for each additional monitor 12b-12z attached.

In one embodiment, each monitor's 12a-12z connectivity lets it know if at least one neighbor is present and if so, defines itself in a “top of”, “bottom of”, “left of”, “right of” and/or the like relationship to its neighbor. The system 10 employs a nearest neighbor transmission which sends a signal at power on time which ripples through the network causing other monitors 12a-12z in the immediate vicinity to adjust their internal view of the world according to its position in the network of monitors. In another embodiment, each monitor 12a-12z could then use only the portion of the signal meant for it and relay the remainder signal on to the next monitor.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A system comprising:
a plurality of monitors;
a sensor carried by each of the plurality of monitors; and
a controller to at least one of detect and configure the plurality of monitors to display at least one video signal image based upon individual monitor parameters provided by each respective sensor to the controller.

2. The system of claim 1 wherein the individual monitor parameters includes at least one of monitor's spatial position, monitor's spatial position relative to the other monitors, and monitor imaging settings.

3. The system of claim 1 wherein each sensor comprises at least one of a personal area network technology and a wireless personal area network technology.

4. The system of claim 3 wherein the wireless personal area network technology comprises a radio-frequency identification tag, infrared data association unit, ZigBee transceiver, Bluetooth unit, optical coupler, and ultra-wideband unit.

5. The system of claim 1 wherein the controller is carried by at least one of a primary monitor, a video card, and a computer system.

6. The system of claim 1 wherein the controller transmits a nearest neighbor signal that ripples through the plurality of monitors thereby permitting each monitor to adjust its individual monitor parameters based upon each monitor's spatial position relative to the other monitors.

7. The system of claim 6 wherein each monitor uses a portion of a video image signal ascribed to it by the controller and relays the remaining portion downstream to the other monitors.

8. The system of claim 1 wherein each sensor comprises a plurality of sensors arranged on each monitor that aid the controller in identifying each monitor's location relative to the other monitors.

9. The system of claim 1 wherein communications between the controller and each sensor is substantially restricted to the controller and each sensor.

10. A system comprising:
a plurality of monitors;
a sensor carried by each of the plurality of monitors; and
a controller to at least one of detect and configure the plurality of monitors to display at least one video signal image based upon individual monitor parameters provided by each sensor to the controller, the controller transmitting a nearest neighbor signal that ripples through the plurality of monitors thereby permitting each monitor to adjust its individual monitor parameters based upon each monitor's spatial position relative to the other monitors, and communications between the controller and each sensor is substantially restricted to the controller and each sensor.

11. The system of claim 10 wherein the individual monitor parameters includes at least one of monitor's spatial position, and monitor imaging settings.

12. The system of claim 10 wherein each sensor comprises at least one of a personal area network technology and a wireless personal area network technology.

13. The system of claim 12 wherein the wireless personal area network technology comprises a radio-frequency identification tag, infrared data association unit, ZigBee transceiver, Bluetooth unit, optical coupler, and ultra-wideband unit.

14. The system of claim 10 wherein each monitor uses a portion of a video image signal ascribed to it by the controller and relays the remaining portion downstream to the other monitors.

15. The system of claim 10 wherein each sensor comprises a plurality of sensors arranged on each monitor that aid the controller in identifying each monitor's location relative to the other monitors.

16. A method to configure monitors, the method comprising:
configuring each of a plurality of monitors to carry a wireless personal area network sensor; and
at least one of detecting and configuring the plurality of monitors with a controller to display at least one video signal image based upon individual monitor parameters provided by each sensor to the controller, and communications between the controller and each sensor is substantially restricted to the controller and each sensor.

17. The method of claim 16 further comprising including at least one of monitor's spatial position, monitor's spatial position relative to the other monitors, and monitor imaging settings as the individual monitor parameters.

18. The method of claim 16 further comprising transmitting, via the controller, a nearest neighbor signal that ripples through the plurality of monitors thereby permitting each monitor to adjust its individual monitor parameters based upon each monitor's spatial position relative to the other monitors.

19. The method of claim 16 further comprising using a portion of a video image signal by each monitor where the portion is ascribed to each monitor by the controller and relaying the remaining portion downstream to the other monitors.

20. The method of claim 16 further comprising aiding the controller in identifying each monitor's location relative to the other monitors where each sensor comprises a plurality of sensors arranged on each monitor.
